(19) United States
(12) Patent Application Publication
(10) Pub. No.: US 2005/0093692 A1
(43) Pub. Date: May 5, 2005

(54) Information processing device having external notification function and notification method thereof

(75) Inventors: Kyoichi Nakaguma, Yokohama (JP); Shigeki Hataya, Yokohama (JP); Hideki Nakamura, Yokohama (JP); Toru Yokozawa, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/808,930

(22) Filed: Mar. 24, 2004

(30) Foreign Application Priority Data
Nov. 5, 2003 (JP) 2003-375090

(51) Int. Cl. G08B 1/08

(52) U.S. Cl. 340/539.13; 340/573.1

(57) ABSTRACT

In an information processing device of the present invention, the current position of the information processing device is obtained by a communication unit and a position information obtaining unit. Information on a device used by a user and information on his operation are obtained by an act detection unit. Act information describing when, where, and what operation the user is prohibited or permitted to perform is obtained by an act information list obtaining unit. A match determination unit determines whether the user has performed an act associated with the act information, and whether the current position of the information processing device matches the position included in the act information and a current time matches the time included in the act information. An act notification unit reproduces a message included in the act information and automatically notifies others of performance of the act using the communication unit.

### BACKGROUND OF THE INVENTION

The present invention relates to an information processing device having a communication function, which can improve manners in a scene of use, and its notification method.

In recent years, multifunctions have been introduced into information processing devices such as a cellular phone, and advanced functions have been achieved: the communication function enabling communication by Internet or E-mail can be used anywhere, at any time, and an imaging function such as the one of a digital camera or a handy cam is equipped with the information processing device. Thus, the information processing device with such advanced functions are becoming essential in daily life. However, in actuality, depending on the function of the information processing device, the function may not be used anywhere, at any time. Taking a picture of a magazine article in a bookstore by the cellular phone with the digital camera, for example, has become a social problem as an act against social manners.

Such an act can be prevented to a certain extent by using a prior art disclosed in JP-A-2000-152217, which prohibits photographing depending on the place where the information processing device is used.

### SUMMARY OF THE INVENTION

However, the prior art disclosed in JP-A-2000-152217 just stops the function as the camera, and cannot cope with prohibited acts other than photographing. Further, a user cannot know that the photographing is prohibited though he knows that he cannot use the function as the camera. In addition, when the user dares to perform the prohibited act even if he is alerted not to use this function, a scheme for automatically contacting a security institution becomes necessary so as to deter crime.

The present invention has been made to solve these problems. It is therefore an object of the present invention is to provide a scheme for an information processing device, for automatically notifying a user that an act he is going to perform is prohibited or permitted depending on a position where the information processing device is placed, and automatically notifying others that the user has performed or is going to perform a prohibited act.

In order to solve the problems described above, the present invention adopts the following configuration:

An information processing device according to the present invention includes:
a communication unit for performing communication with an outside;
a position information obtaining unit for identifying the current position of the information processing device through communication with a positioning satellite such as a GPS satellite or an information server using the communication unit;
a time information obtaining unit for obtaining a current time;
a memory storing act information each including user information for identifying a user and information for identifying a device, an operation, a position, a time, and permission or prohibition of an act of the user;
an act information list obtaining unit for obtaining a list of the act information;
a position determination unit for comparing position information recorded in one of the act information and position information obtained by the position information obtaining unit to determine a match therebetween;
an act detection unit for detecting the act of the user and obtaining the device used and the content of the operation;
a match determination unit for comparing act information obtained by the position determination unit, the time information obtaining unit, and the act detection unit with the act information stored in the memory to determine a match therebetween; and
an act notification unit for notifying the user of permission or prohibition of the act when the act has been detected by the match determination unit.

An information server connected to the communication unit of the information processing device of the present invention includes:
a communication unit for performing communication with the information processing device; and
a memory for holding position information indicating a position in which the information server is placed and proximity act information, the proximity act information being the act information to be applied only within a range in which the information processing device can communicate with the information server.

A scheme for notifying the user that an act the user is going to perform is not permitted depending on the position where the information processing device is placed, which is an object of the present invention, is implemented by operations as follows:

The information processing device performs communication with the positioning satellite such as the GPS satellite using the communication unit. Alternatively, the information processing device performs communication with the communication unit of the information server to receive information. The position information obtaining unit processes information from the positioning satellite such as the GPS satellite, thereby obtaining information on the current position indicating a location where the information processing device is placed on Earth or a position where the user is going to perform an act. Alternatively, the information processing device uses the communication unit therein to obtain position information stored in the memory of the information server. The time information obtaining unit obtains a current time or a time when the user is going to perform the act. The act detection unit obtains the content of an operation the user has performed on the information processing device. The act the user is going to perform includes a processing request for an operation on the information processing device or the act of movement to a specific place.

More specifically, which device in the information processing device the user has operated and the content of the operation are converted to information as a device identifier and an operation identifier, respectively, and obtained. The act information list obtaining unit obtains act information included in the memory of the information processing device. The act information is the information constituted from attribute information indicating permission or prohibition of an act of the user, position information, time information, the device identifier, the operation identifier, a message, and a contact address, and is the information that describes when, where, and what operation the user is permitted or prohibited to perform.

The act information list obtaining unit communicates with the information server using the communication unit and obtains proximity act information stored in the memory of the information server. The proximity act information is the act information to be applied only in the range in which the information server and the information processing device can communicate each other using their communication units. The proximity act information is constituted from attribute information, time information, a device identifier, an operation identifier, a message, and a contact address, for example.

The position information of the proximity act information is the position information stored in the memory of the information server. The position determination unit compares the position information obtained by the position information obtaining unit with the position information included in the act information obtained by the act information list obtaining unit to determine a match therebetween, with a positioning error of the position information obtaining unit allowed. The match determination unit compares the device identifier and the operation identifier obtained by the act detection unit, time information obtained by the time information obtaining unit, and the position information obtained by the position information obtaining unit with the device identifier, operation identifier, time information, and position information included in the act information obtained by the act information list obtaining unit to determine whether the device identifiers match, whether the operation identifiers match, whether the time information match, and whether the position information match.

The act notification unit obtains the message included in the act information when the matches have been determined by the match detection unit, and notifies the user of the message, using a display device or a sound source device of the information processing device.

The operations as described above make it possible to notify the user that an act the user is going to perform is not permitted depending on the position in which the information processing device is placed. Further, the scheme for automatically notifying others of performance of an act, which is another object of the present invention is implemented by operations as follows:

The match determination unit determines performance of an act by the user using respective functions of the units in the information processing device. When the matches in the act information have been detected by the match determination unit and the act information is a prohibited attribute, the communication unit obtains information on a specific contact address in the act information and starts communication. The information on the contact address is the information that can uniquely identify others such as the telephone number, IP address, or mail address of others. At the same time, the message included in the act information and information that identifies the user, stored in the memory of the information processing device are transmitted to the contact address using the communication unit. By the operations as described above, performance of the act can be automatically notified to others.

A notification method in an information processing device according to the present invention comprises:
the step of detecting an act by a user or a processing request for the information processing device; and
at least one of the steps of obtaining position information and obtaining time information;
wherein when a specific act or a specific processing request by a predetermined user has been performed at a specific position or a specific time, performance of the specific act or the specific processing request by the user is notified.

As described above, according to the present invention, improvement in manners becomes possible.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing an information processing device according to the present invention;

FIG. 2 is an explanatory drawing showing a list of act information;

FIG. 3 is an explanatory drawing showing a list of proximity act information;

FIG. 4 is a flowchart of operations when units according to the present invention have been activated;

FIG. 5 is a flowchart of the operation of obtaining the current position of the information processing device and receiving a list of proximity act information;

FIG. 6 is a flowchart of the operation of obtaining information on an act of a user;

FIG. 7 is a flowchart of the operation of retrieving information on the act and determining whether the act is prohibited or not; and

FIG. 8 is a flowchart of the operation of informing the user that the act is prohibited or not.

### DETAILED DESCRIPTION OF THE EMBODIMENT

An embodiment of the present invention will be described below with reference to the accompanying drawings.

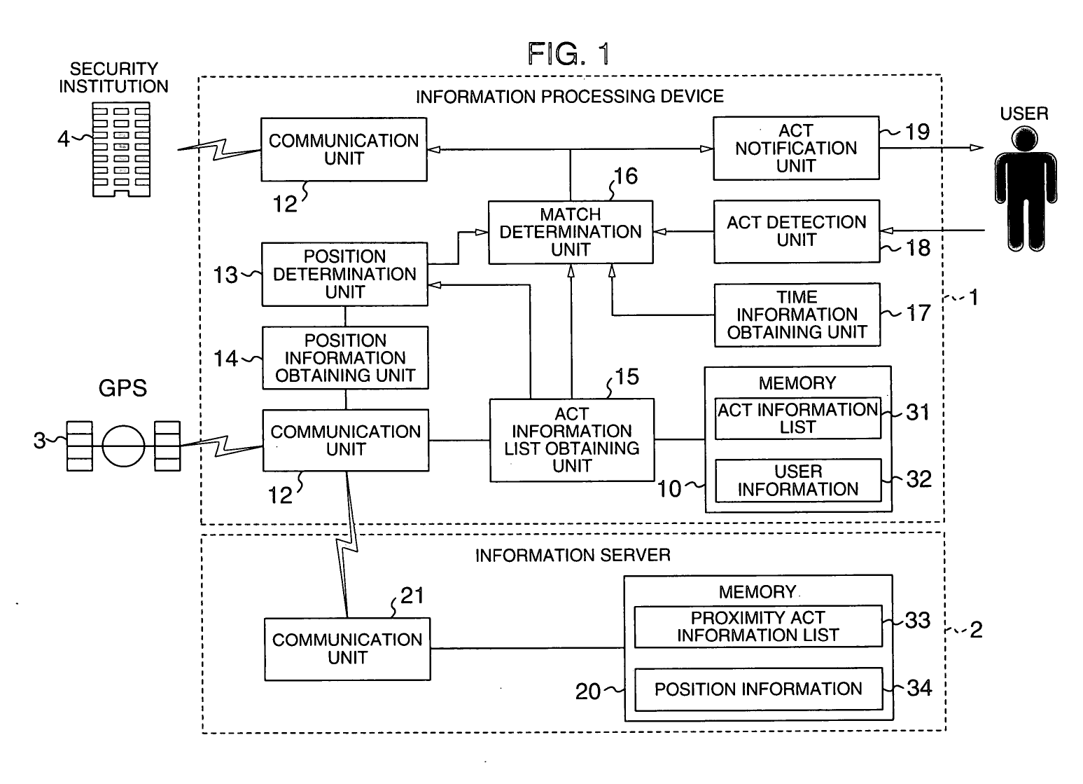

FIG. 1 is a block diagram showing a configuration of an information processing device according to the embodiment of the present invention.

An information processing device 1 includes a memory 10, a communication unit 12, a position determination unit 13, a position information obtaining unit 14, an act information list obtaining unit 15, a match determination unit 16, a time information obtaining unit 17, an act detection unit 18, and an act notification unit 19. The memory 10 is used when a program is executed and is used as a program work area. The memory 10 is constituted from an act information list 31 and user information 32 for identifying a user. The communication unit 12 communicates with a GPS satellite 3, an information server 2, and a security institution 4. The position information obtaining unit 14 communicates with the GPS satellite 3 for information for pinpointing the position of the information processing device on Earth, or obtains position information 34 stored in a memory 20 of the information server 2, using the communication unit 12 and a communication unit 21. The act information list obtaining unit 15 obtains a list of act information stored in the memory 10. The time information obtaining unit 17 obtains a current time. The position determination unit 13 compares position information 34 obtained by the position information obtaining unit 14 with position information 111 included in act information 110 obtained by the act information list obtaining unit 15 to determine whether the position information 111 matches the position information 34 with a positioning error of the position information obtaining unit 14 allowed. The act detection unit 18 detects an act of a user and obtains the device identifier of a used device and an operation identifier for identifying the content of an operation. The match determination unit 16 compares the device identifier and the operation identifier obtained by the act detection unit 18, information on the time obtained by the time information obtaining unit 17, and the position information obtained by the position information obtaining unit 14 with a device identifier 113, an operation identifier 114, time information 112, and the position information 111 included in the act information 110 obtained by the act information list obtaining unit 15, respectively to determine whether the device identifiers match, whether the operation identifiers match, whether the times match, and whether the positions match. The act notification unit 19 obtains a message 115 included the act information 110 when the match determination unit 16 has determined that the information on the act detected by the act detection unit 18 matches the act information 110, and notifies the user of the message using a display device or a sound source provided for the information processing device 1. The communication unit 12 obtains contact address information 116 included in the act information 110 and starts communication when attribute information 117 of the act information 110 obtained by the act information obtaining unit 15 is a prohibited attribute, and transmits the message 115 included in the act information 110 and the user information 32 for identifying the user, stored in the memory 10 of the information processing device 1 to an associated contact address.

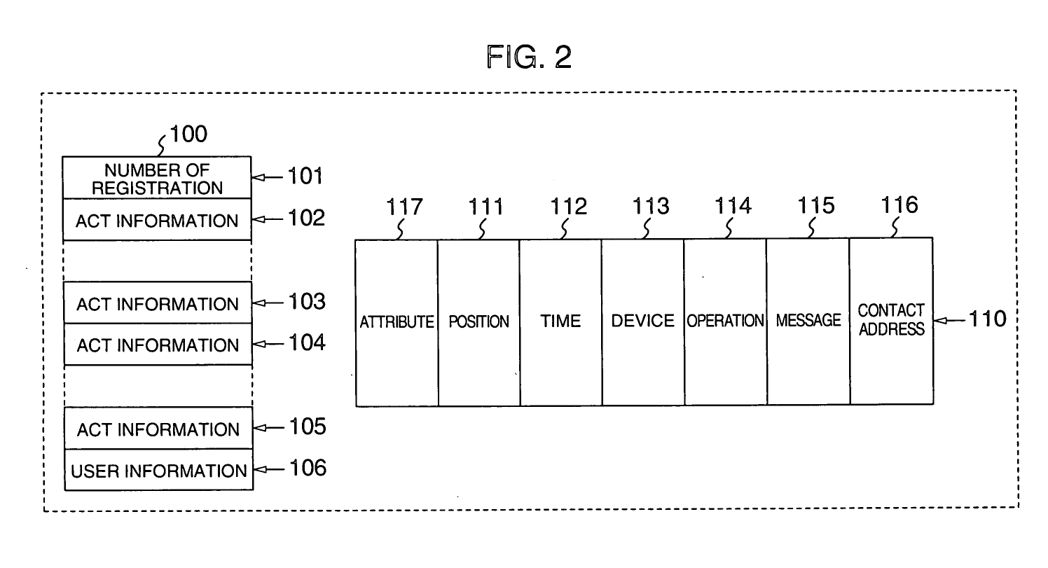

The memory 10 of the information processing device 1 will be described with reference to FIG. 2.

The memory 10 is constituted from the user information 32 and the act information list 31. The user information 32 is the information for identifying the user who uses the information processing device 1, and may be any information identifying the user, such as the name of the user or the insurer number of the user. In short, the user information 32 may the information a third party obtains and by which he can identify the user.

An act information list 100, which corresponds to the act information list 31 in FIG. 1 is constituted from the number of registration 101 and a plurality of act information 110. The act information list 100 groups the act information 110, the number of which is indicated by the number of registration 101, as in act information 102 to 105 in FIG. 2. The act information 110 is constituted from the position information 111, time information 112, device identifier 113, operation identifier 114, message 115, contact address information 116, and attribute information 117. The position information 111 is the information identifying the position of the information processing device on Earth, such as the information of positioning using the GPS satellite or the information of a latitude-longitude pair for the information processing device. The time information 112 is the information indicating a time zone having a certain time range, and is the information indicating a year-day-hour-minute-second range. In short, the time information 112 may be the information indicating whether a certain specified time is within the time zone.

The device identifier 113 is the information for identifying a device provided for the information processing device 1. If the information processing device 1 has an image pickup function, the device identifier is the one for identifying a camera device. If the information processing device 1 has a recording function, the device identifier is the one for identifying a microphone device. The operation identifier 114 is the identifier indicating the operation of the device identified by the device identifier 113, using a unique numeral value. The message 115 is the information presented to the user when the conditions in the act information 110 and the information obtained by the act detection unit 18, the time information acquiring unit 17, and position information acquiring unit 14 have matched.

Accordingly, the message 115 may be a character string such as “ . . . is currently prohibited”, PCM information for causing the user to hear the sentence as described above by voice, or a moving image for informing the user of the prohibition. In short, it is the message alerting the user to performance of an act. When the user has performed an act, he needs to notify appropriate others that the user has performed the act; the contact address information 116 is the information indicating the contact address of the appropriate others. If the appropriate others is the police, the “telephone number 110” or the home page address of security service is the contact address. In short, the contact address information 116 is the information identifying the other party to whom performance of an act indicated by the act information 110 is notified. The attribute information 117 is the information indicating whether the act information 110 is a prohibited act or a permitted act. As described above, notification of an act of the user identified by the position information 111, time information 112, device identifier 113, and operation identifier 114 of the act information 110 specified by the message 115 and the contact address information 116 becomes possible.

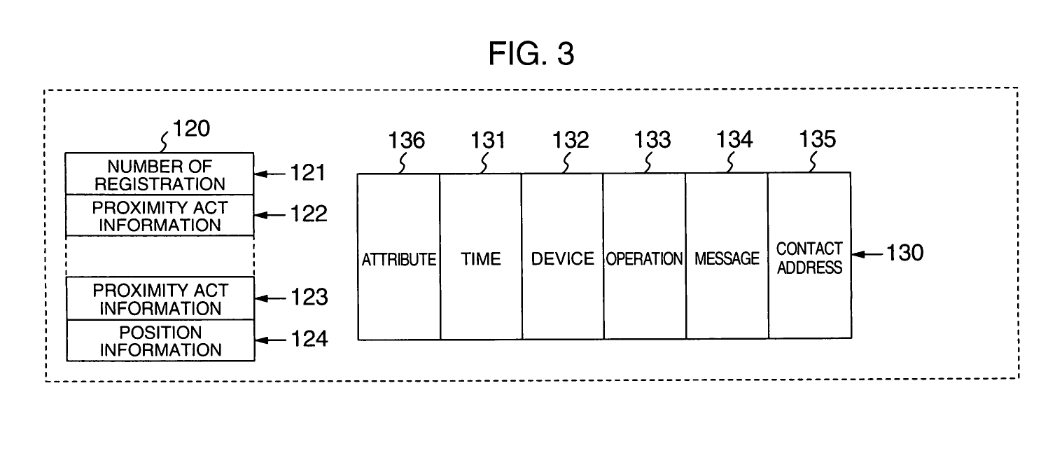

Next, the memory 20 of the information server 2 will be described with reference to FIG. 3.

The memory 20 of the information server 2 is constituted from the position information 34 and proximity act information list 33. The position information 34 is the information for identifying the position of the information server 2 on Earth, and is the information of positioning using the GPS satellite, or the information of the latitude-longitude pair. This can identify the location of the information server 2 with which the information processing device 1 communicates using the communication unit 12.

The proximity act information list 33 is constituted from the number of registration 121 and a plurality of proximity act information 130. The proximity act information list 33 groups the act information 130, the number of which is indicated by the number of registration 121, as in proximity act information 122 to 123 in FIG. 3. The proximity act information 130 is constituted from time information 131, a device identifier 132, an operation identifier 133, a message 134, contact address information 135, and attribute information 136.

The time information 131 is the information indicating a time zone having a certain time range. The time information 131 is the information indicating a year-day-hour-minute-second range. In short, the time information 131 may be the information indicating whether a certain specified time is within the time zone.

The device identifier 132 is the information for identifying a device provided for the information processing device 1. The device identifier 132 is the information indicated by a numerical value assigned to the identifier for the device such as a camera or a microphone provided for a portable information processing device such as a cellular phone or a PDA.

The operation identifier 133 is the identifier for the operation of the device identified by the device identifier 132, indicated by a unique numerical value.

The message 134 is the information presented to the user when conditions in the act information 130 have matched information obtained by the act detection unit 18, time information obtaining unit 17, and position information obtaining unit 14, so that the user was found to have performed an act.

Accordingly, the message 134 may be the character string such as “ . . . is currently prohibited”, the PCM information for causing the user to hear the sentence as described above by voice, or the moving image for notifying the user of the prohibition. In short, it is the message representing an instruction prompting the user to stop performance of the act.

When the user has performed an act, he needs to notify the appropriate others that he has performed the act; the contact address information 135 is the information indicating the contact address of the appropriate others. Like the contact address information 116 in the act information 110, the contact address information 135 is the information indicating the contact address of the police, the security service, or the contact address of a business owner who disposes the information server 2. In short, it is the information for identifying the other party to whom performance of an act indicated by the proximity act information 130 is notified.

The attribute information 136 is the information indicating whether the proximity act information 130 is a prohibited act or a permitted act. As described above, notification of an act of the user identified by the time information 131, device identifier 132, and operation identifier 133 of the proximity act information 130 specified by the message 134 and the contact address 135 becomes possible.

Next, the embodiment of the present invention will be described with reference to the flowcharts.

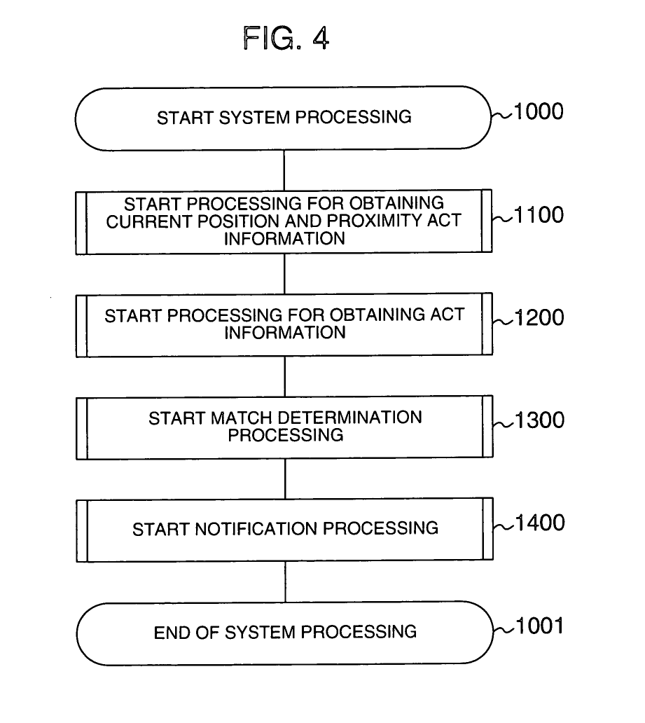

A scheme for notifying the user that an act to be performed by him is prohibited or permitted depending on the position in which the information processing device 1 is placed, and automatically notifying others that the user has performed the act will be described with reference to FIGS. 4, 5, 6, and 7.

In this embodiment, for convenience in description, a description is directed to a case where the units in the information processing device 1 are implemented by a real-time multitasking operating system (OS). However, particular specification of the OS is not necessary so as to achieve the object of this embodiment. The real-time multitasking OS was employed for convenience in brief description of this embodiment.

First, start of processing in this embodiment will be described with reference to FIG. 4.

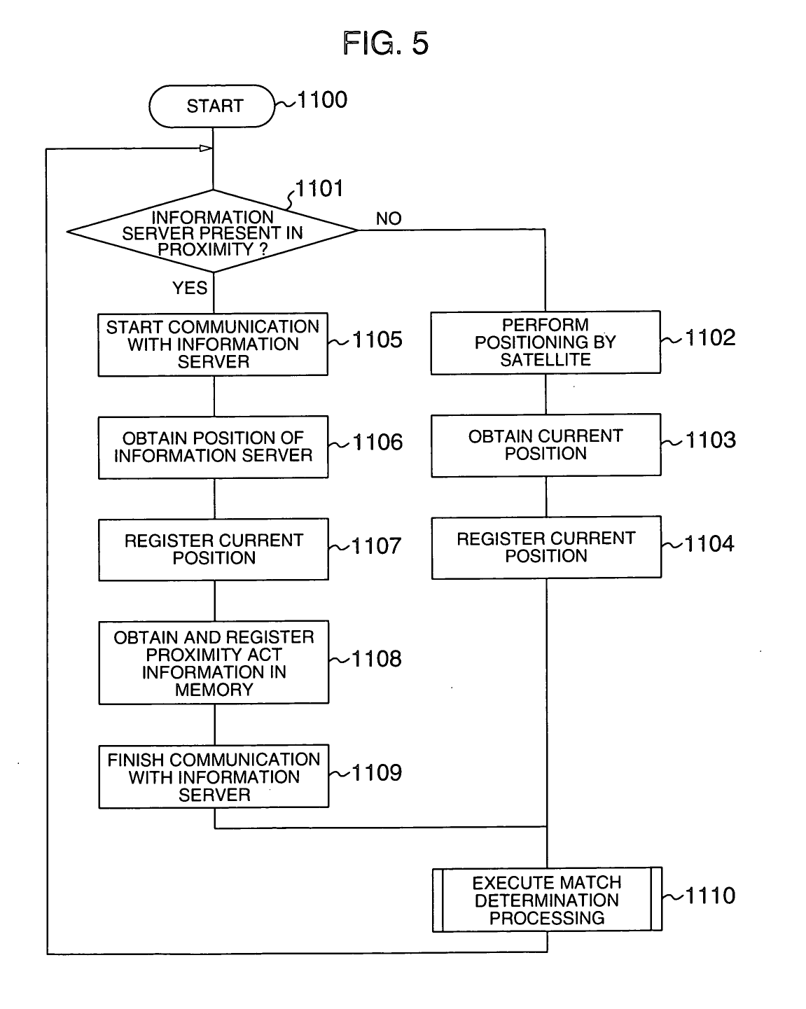

At step 1000, the information processing device 1 is activated. Then, processing for obtaining current position and proximity act information, which will be described later with reference to FIG. 5 is started at step 1100. This makes it possible to constantly obtain the current position of the information processing device 1, and also to obtain the proximity act information list 33 and the position information 34 from the information server 2 if the information server 2 exists in proximity to the information processing device 1.

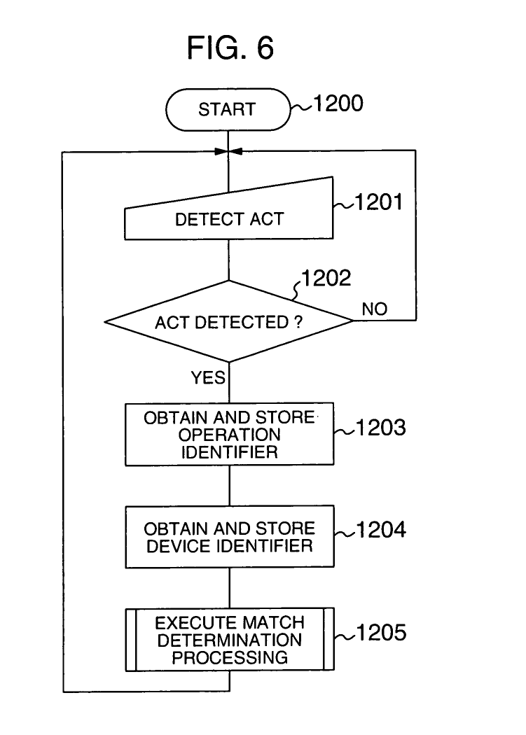

Next, processing for obtaining act information, which will be described later with reference to FIG. 6, is started at step 1200. This makes it possible to constantly obtain information on what act the user has performed during operation of the information processing device 1.

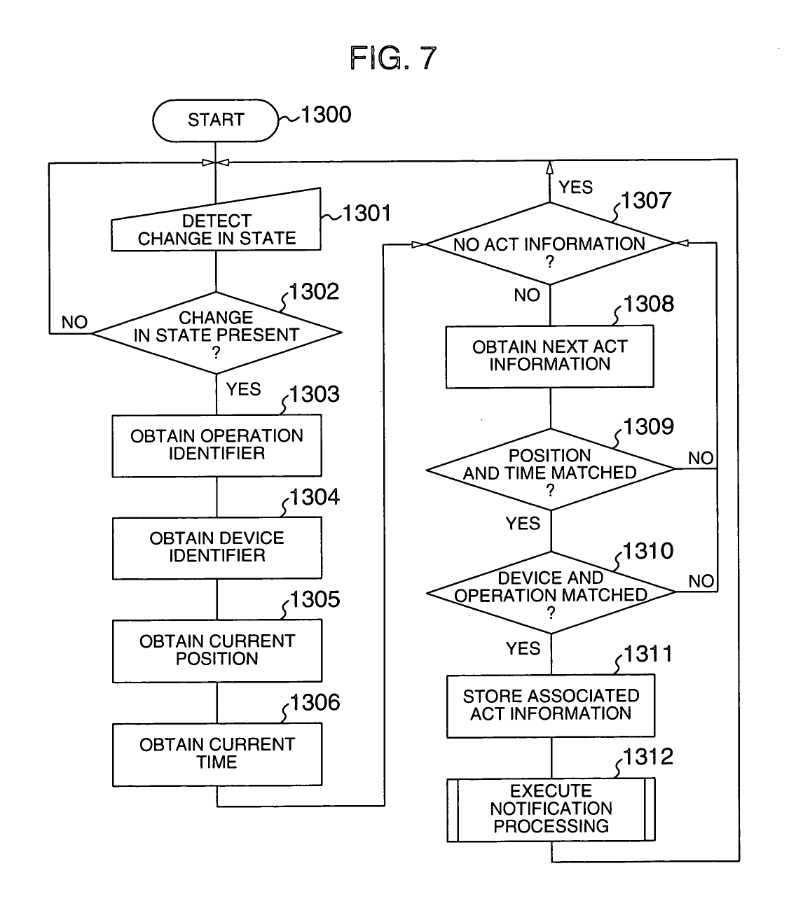

Next, match determination processing, which will be described later with reference to FIG. 7 is started at step 1300. This makes it possible to determine the current position of the information processing device 1 and determine whether the act of the user is prohibited or not at a timing where new information has been obtained during the processing for obtaining current position and proximity act information at step 1100 or the processing for obtaining act information at step 1200.

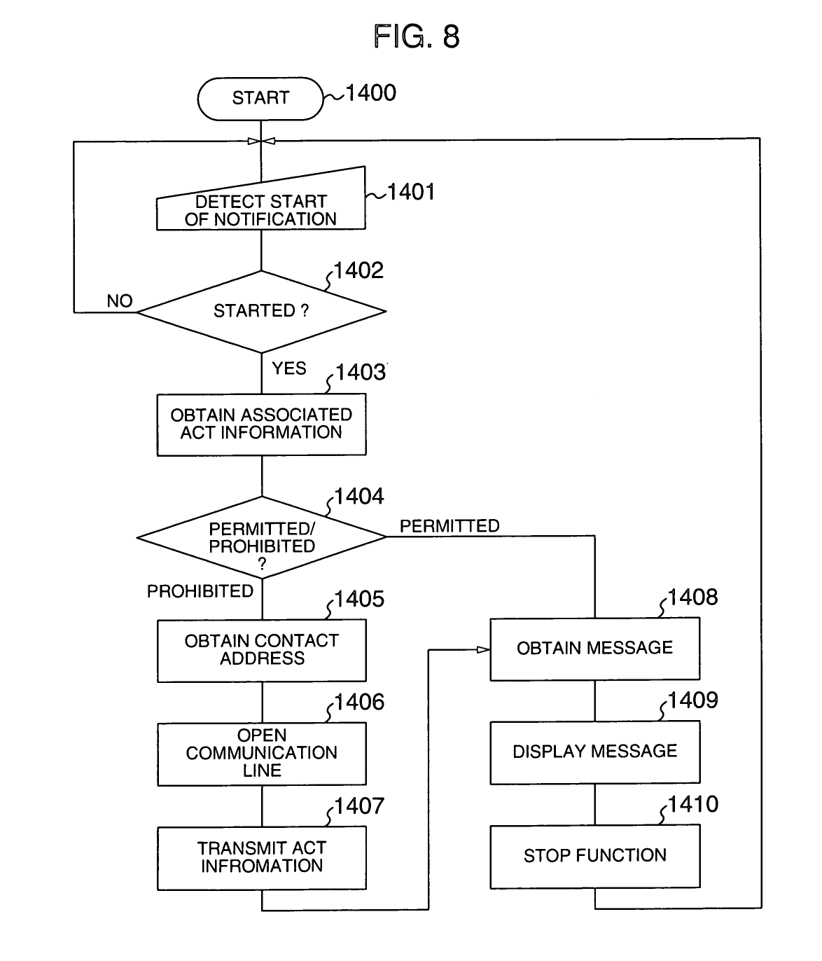

Next, notification processing at step 1400, which will be described later with reference to FIG. 8, is started. This makes it possible to notify the user at a timing where the act has been detected by the match determination processing at step 1300 and also to prohibit use of the device operated by the user. Further, this makes it possible to automatically notify the contact address that the act has been performed.

Next, the processing for obtaining current position and proximity act information at step 1100 will be described with reference to FIG. 5.

After the processing for obtaining current position and proximity act information has been started at step 1100, it is first determined whether the information server 2 exists in proximity to the information processing device 1, using the communication unit 12, at step 1101. If it has been determined that the information server 2 exists, communication with the information server 2 is started at step 1105. If it has been determined that the information server 2 does not exist, positioning by the satellite is started at step 1102. After the communication with the information server 2 has been started at step 1105, the position information 34 is obtained from the memory 20 using the communication unit 21 of the information server 2 at step 1106, and stored in the memory 10 of the information processing device 1 at step 1107.

Next, the proximity act information list 33 is obtained from the memory 20 using the communication unit 21 of the information server 2 and stored in the memory 10 at step 1108, and a communication line with the information server 2 is disconnected at step 1109. Then, execution of the match determination processing at step 1110 is started, and the operation returns to step 1101.

When it has been determined at step 1101 that the information server 2 does not exist, information of positioning by the GPS satellite 3 at step 1102 is received using the communication unit 12 to obtain information indicating which position on Earth the information processing device 1 is located, at step 1103. Then, when the current position of the information processing device 1 has been obtained, information of the current position is stored in the memory 10 at step 1104. Then, the operation at step 1110 is performed, and the operation returns to step 1101. This makes it possible to constantly obtain the current position of the information processing device 1 and also to obtain the proximity act information list 33 and the position information 34 if the information server 2 exists in proximity to the information processing device 1.

Next, the processing for obtaining act information at step 1200 in FIG. 4 will be described with reference to FIG. 6.

After the processing for obtaining act information has been started at step 1200, it is detected whether the user is operating a device provided for the information processing device 1 or not, at step 1201. If it has been detected that he is not operating the device at step 1202, detection of an act is repeated at step 1201. If it has been detected that he is operating the device, the operation identifier 114 or 133 indicating the content of the operation is obtained and stored at step 1203. At the same time, identification of which device is being operated is performed, and the device identifier 113 or 132 for the device is obtained and stored at step 1204. After the device identifier 113 or 132 and the operation identifier 114 or 133 have been stored, the match determination processing is performed at step 1205. Then, the operation returns to step 1201, and the processing for obtaining act information at step 1200 is continuously performed. This makes it possible to constantly obtain information on what act the user has performed during his operation of the information processing device 1.

Next, the match determination processing at step 1300 in FIG. 4 will be described with reference to FIG. 7.

After the match determination processing at step 1300 has been started, it is first detected at step 1301 whether the current position of the information processing device 1, proximity act information list 33, and position information 34 have been obtained by the processing for obtaining current position and proximity act information at step 1100, or the device identifier 113 or 132 and the operation identifier 114 or 133 have been obtained by the processing for obtaining act information at step 1200. If no change in the state of the information processing device 1 has been detected at step 1302, the operation at step 1301 is repeated. If a change in the state of the information processing device 1 has been detected at step 1302, the operation identifier 114 or 133 is obtained at step 1303. Then, the device identifier 113 or 132 is obtained at step 1304, and the position information obtained from the information server 2 or the GPS satellite 3 is obtained at step 1305. Then, a current time is obtained at step 1306. Next, processing for obtaining the act information 110 one by one from the act information list 100 stored in the memory 10 is performed at step 1308. If it has been found at step 1307 that there is no act information 110, the operation returns to step 1301, and the match determination processing at step 1300 is resumed. If it has been found that the act information 110 is present, the position information 111 and the time information 112 included in the act information 110 are compared with the position information and the current time obtained at steps 1305 and 1306, respectively, at step 1309. If there is no match, the operation returns to step 1307, and the next act information 110 is obtained at step 1308.

If the match between the position information and the match between the time information have been detected at step 1309, the device identifier 113 and the operation identifier 114 included in the act information 110 are compared with the device identifier and the operation identifier obtained at steps 1303 and 1304, respectively, at step 1310. If there is no match, the operation returns to step 1307, and the next act information 110 is obtained at step 1308. If the match between the device identifiers and the match between the operation identifiers have been detected, the associated act information 110 is stored in the memory 10, and the notification processing at step 1400, which will be described later, is started at step 1312. Then, the operation returns to step 1301, and the match determination processing at step 1300 is repeated. This makes it possible to determine the current position of the information processing device 1 and determine whether the act of the user is prohibited or not at a timing where new information has been obtained during the processing for obtaining current position and proximity act information at step 1100 or the processing for obtaining act information at step 1200. In regard to acquisition of the next act information at step 1308, if the act information list 100 in the memory 10 has been all retrieved, the proximity act information list 33 obtained from the memory 20 in the information server 2 at step 1108 in FIG. 5 is retrieved. This makes it possible to perform match determination about the proximity act information 130 as well if the information server 2 exists in proximity to the information server 2.

Next, the notification processing at step 1400 in FIG. 4 will be described with reference to FIG. 8.

After the notification processing has been started at step 1400, it is first detected whether the associated act information 110 is stored in the memory 10 by the match detection processing at step 1300, at step 1401. If the associated act information 110 is not stored, the operation returns to step 1401, and the notification processing at step 1400 is repeated, at step 1402. If the associated act information 110 is stored, the act information 110 is obtained at step 1403. Next, the attribute information 117 of the act information 110 is checked at step 1404. If it has been found that the attribute information 117 is a prohibited attribute, the contact address information 116 is obtained at step 1405. Then, a communication line is opened using the communication unit 12 at step 1406. Then, the associated act information 110 is transmitted at step 1407. Next, the message 115 is obtained at step 1408, and reproduced using the display device or the sound source device in the information processing device 1 at step 1409, thereby notifying that the user has performed the act. Next, the function of the device associated with the device identifier 113 of the act information 110 is stopped at step 1410, and the operation returns to step 1401.

If it has been found at step 1404 that the attribute information 117 of the associated act information 110 is a permitted attribute, the operations at steps 1408, 1409, and 1410 are performed. Then, the operation returns to step 1401. This makes it possible to notify the user of permission or prohibition of the act at a timing where the act has been detected by the match detection processing at step 1300 and also to prohibit use of the device. Further, this makes it possible to notify the contact address that the act has been automatically performed.

By using the functional operations as described above, the function of notifying the user that an act being performed by the user is not permitted depending on the position where the information processing device 1 is placed and the function of automatically notifying others that the user has performed the act can be achieved.

As described above, the information processing device 1 according to the present invention achieves the function of notifying the user that an act being performed by the user is not permitted depending on the position where the information processing device 1 is placed and the function of automatically notifying others that the user has performed the act. These functions make it possible to implement a scheme for restricting the functions of the information processing device 1 used by the user according to the place where the information processing device 1 is placed, so that improvement in manners in a scene of use becomes possible.

It should be further understood by those skilled in the art that although the foregoing description has been made on embodiments of the invention, the invention is not limited thereto and various changes and modifications may be made without departing from the spirit of the invention and the scope of the appended claims.

1. An information processing device having a communication unit for communicating with an outside, the information processing device comprising:
a position information obtaining unit for obtaining position information;
a time information obtaining unit for obtaining time information;
a storage unit for storing a list of act information for identifying an act of a user;
an act detection unit for detecting the act of the user;
a determination unit for determining whether information on the act detected by the act detection unit and the position information obtained by the position information obtaining unit or the time information obtained by the time information obtaining unit match respective associated information in one of the act information in the act information list; and
a notification unit for, when the matches in the information have been detected by the determination unit, notifying performance of a specific act.

2. The information processing device according to claim 1, wherein notification unit notifies the performance of the specific act by one or a combination of voice, a still image, and a moving image.

3. The information processing device according to claim 1, wherein the position information obtained by the position information obtaining unit and the time information obtained by the time information obtaining unit are information of a current position of the information processing device and information of a current time, respectively.

4. The information processing device according to claim 1, wherein when the matches in the information have been detected by the determination unit, the communication unit notifies the performance of the specific act to a specific destination of communication.

5. The information processing device according to claim 1, wherein the information processing device further comprises an act information list obtaining unit for obtaining an act information list from an external information server through communication, and stores the obtained act information list in the storage unit.

6. An information processing device having a communication unit for communicating with an outside, the information processing device comprising:
a position information obtaining unit for obtaining position information;
a time information obtaining unit for obtaining time information;
a storage unit for storing a list of processing request information for identifying a processing request from a user;
a processing request detection unit for detecting the processing request from the user;
a determination unit for determining whether information on the processing request detected by the processing request detection unit and the position information obtained by the position information obtaining unit or the time information obtained by the time information obtaining unit match respective associated information in one of the processing request information in the processing request information list; and
a notifying unit for, when the matches in the information have been detected by the determination unit, notifying execution of a specific processing request or planned execution of the specific processing request.

7. The information processing device according to claim 6, wherein the notifying unit notifies the execution of the specific processing request by one or a combination of voice, a still image, and a moving image.

8. An information processing device having a communication unit for performing wireless or wired communication, the information processing device comprising:
a position information obtaining unit for obtaining position information;
a time information obtaining unit for obtaining time information;
a storage unit for storing a list of act information for identifying an act of a user;
an act detection unit for detecting the act of the user;
a determination unit for determining whether information on the act detected by the act detection unit and the position information obtained by the position information obtaining unit or the time information obtained by the time information obtaining unit match respective associated information in one of the act information in the act information list; and
a notifying unit for, when the matches in the information have been detected by the determination unit, notifying planned performance of a specific act.

9. The information processing device according to claim 8, wherein when the matches in the information have been detected by the determination unit, all or a part of functions of the information processing device employed for the planned performance of the specific act are stopped.

10. An information processing device having a communication unit for communicating with an outside, the information processing device comprising:
a time information obtaining unit for obtaining time information;
an act information list obtaining unit for obtaining a list of act information for identifying an act of a user;
an act detection unit for detecting the act of the user;
a determination unit for determining whether information on the act detected by the act detection unit and the time information obtained by the time information obtaining unit match respective associated information in one of the act information in the act information list; and
a notifying unit for, when the matches in the information have been detected by the determination unit, notifying performance of a specific act.

11. The information processing device according to claim 10, wherein the act information list obtaining unit obtains an act information list from an information server in proximity to the information processing device.

12. The information processing device according to claim 10 or 11, wherein the information processing device further comprises a position information obtaining unit for obtaining information of a current position of the information processing device, and the determination unit detects a match between the current position of the information processing device obtained by the position information obtaining unit and position information in one of the act information in the act information list obtained by the act information list obtaining unit.

13. The information processing device according to claim 10, wherein the notifying unit notifies the performance of the specific act by one or a combination of voice, a still image, and a moving image.

14. The information processing device according to claim 10, wherein when the matches in the information have been detected by the determination unit, the performance of the specific act is notified to a specific destination of communication by the communication unit.

15. An information processing device having a communication unit for communicating with an outside, the information processing device comprising:
a position information obtaining unit for obtaining position information;
a time information obtaining unit for obtaining time information;
an act information list obtaining unit for obtaining a list of act information for identifying an act of a user;
an act detection unit for detecting the act of the user;
a determination unit for determining whether information on the act detected by the act detection unit and the time information of a current time obtained by the time information obtaining unit or the position information of a current position of the information processing device obtained by the position information obtaining unit match respective associated information in one of the act information in the act information list; and
a notifying unit for, when the matches in the information have been detected by the determination unit, notifying a specific act.

16. The information processing device according to claim 15, wherein the act information list obtaining unit obtains a act information list from an information server in proximity to the information processing device; and
the position information obtaining unit for obtaining the position information obtains the position information of the current position of the information processing device from one of act information in the act information list obtained by the act information list obtaining unit.

17. A notification method in an information processing device having a communication unit for performing communication with an outside, the method comprising:
the step of detecting an act of a user; and
at least one of the steps of obtaining position information and obtaining time information;
wherein when a specific act by a predetermined user, detected by the step of detecting, has been performed at a specific position or a specific time, the performance of the specific act by the predetermined user is notified.

18. The notification method according to claim 17, wherein the information processing device obtains information on the specific act and information of the specific position or the specific time from an external information server through communication.

19. A notification method in an information processing device having a communication unit for performing communication with an outside, the method comprising:
the step of detecting a processing request for the information processing device from a user; and
at least one of the steps of obtaining position information and obtaining time information;
wherein when a specific processing request by a predetermined user, detected by the step of detecting has been made at a specific position or a specific time, the making of the specific processing request for the information processing device by the predetermined user is notified.

20. The notification method according to claim 19, wherein the information processing device obtains information on the specific processing request and information of the specific position or the specific time from an external information server through communication.
